(19) United States
(12) Patent Application Publication
(10) Pub. No.: US 2007/0146444 A1
(43) Pub. Date: Jun. 28, 2007

(54) Container having liquid detection function

(76) Inventor: Akihisa Wanibe, Nagano-ken (JP)

Correspondence Address: STROOCK & STROOCK & LAVAN LLP, 180 MAIDEN LANE, NEW YORK, NY, 10038, US

(21) Appl. No.: 11/610,333

(22) Filed: Dec. 13, 2006

(30) Foreign Application Priority Data
Dec. 28, 2005 (JP) 2005-380292

(51) Int. Cl. B41J 2/175

(52) U.S. Cl. 347/85

(57) ABSTRACT

A container includes: a container main body that has a delivery path for delivering liquid stored in the inside to the outside; a sensor accommodating portion that is provided in the container main body to be located in the vicinity of an end of the delivery path; a liquid detection sensor unit that is mounted on the sensor accommodating portion, and has a sensor cavity that receives the liquid as a detection object, a bottom surface of the sensor cavity being opened to receive the liquid, and a sensor chip that has a vibrating plate for closing a top surface of the sensor cavity and a piezoelectric element disposed on a top surface of the vibrating plate; a sensor receiving wall that defines a part of the sensor accommodating portion, and having a first communicating port that allows the liquid stored in the inside to flow into the sensor cavity, and a second communicating port that allows the liquid stored in the sensor cavity to flow to the outside; and an elastic seal member that seals between the sensor unit and the sensor receiving wall and has an upstream seal portion that surrounds and seals the periphery of a part of the delivery path from the inside to the sensor cavity, and a downstream seal portion that surrounds and seals the periphery of a part of the delivery path from the sensor cavity to the outside.

### BACKGROUND

1. Technical Field

The present invention relates to a container having a liquid detection function that is applied to a liquid jetting apparatus, such as an ink jet recording apparatus.

2. Related Art

As a representative one of known liquid jetting apparatuses, there is an ink jet recording apparatus that has an ink jet recording head for image recording. Other liquid jetting apparatuses include, for example, an apparatus having a color material jetting head used in manufacturing color filters of a liquid crystal display or the like, an apparatus having an electrode material (conductive paste) jetting head used in forming electrodes of an organic electroluminescent (EL) display or a surface emission display (FED), an apparatus having a bioorganic compound jetting head used in manufacturing a bio-chip, an apparatus having a sample spraying head as a precision pipette, and so on.

In the ink jet recording apparatus, which is the representative one of the liquid jetting apparatuses, an ink jet recording head has a pressure generating unit for pressurizing a pressure generation chamber and nozzle openings for ejecting pressurized ink as ink droplets. Then, the ink jet recording head is mounted on a carriage. In addition, ink in an ink container is supplied to the recording head through a flow passage in succession, such that printing is continuously performed. The ink container is a detachable cartridge that can be simply replaced by a user when ink is consumed.

As a method of managing ink consumption of the ink cartridge, there is a method of managing an ink cartridge that calculates ink consumption by totalizing the number of ejections of droplets from the recording head or an ink amount absorbed by a maintenance using software, or a method that manages a time, at which ink is actually consumed by a predetermined amount, by attaching liquid level detection electrodes to the ink cartridge.

However, the method that manages ink consumption by the calculation of totalizing the number of ejections of the ink droplets or the ink amount using software has the following problems. Of the heads, there are those having a weight variation between ejected ink droplets. The weight variation between the ink droplets does not have an effect on image quality. However, the ink cartridge is filled with ink in an amount with a margin, taking into consideration of cumulative ink consumption errors due to the variations. Accordingly, there arises a problem in that ink remains in a certain individual by the amount corresponding to the margin.

Meanwhile, the method of managing by the electrodes the time, at which ink is consumed, can detect the actual amount of ink, and thus the ink residual quantity can be managed with high reliability. However, this method relies upon conductivity of ink in detecting the liquid level of ink, and thus having a defect that kinds of detectable ink are limited or an electrode seal structure is complicated. Further, the electrode usually uses a precious metal having good conductivity and high corrosion resistance, and thus manufacturing costs of the ink cartridge may be increased. In addition, since two electrodes need to be attached, the number of manufacturing steps is increased, and thus manufacturing costs are increased.

As one of apparatuses that have been developed in order to solve such a problem, a piezoelectric device (herein, referred to as a sensor unit) is disclosed in Patent Document 1. The sensor unit monitors the ink residual quantity in the ink cartridge by using the fact that a resonant frequency of a residual vibration signal changes due to residual vibration (free vibration) of a vibrating plate after compulsory vibration between the cases of a presence of ink in a cavity facing the vibrating plate having laminated thereon a piezoelectric element and of an absence of ink therein.

Patent Document 1: JP-A-2001-146030

However, when the sensor unit described in Patent Document 1 is used, ink needs to freely enter the cavity facing the vibrating plate, but not to enter the side on which electrical parts, such as the piezoelectric element and so on, are disposed. For this reason, upon attaching, adjacent members need to be closely sealed.

The seal structure include a structure that directly attaches the sensor unit to an edge of an opening of a container main body and a structure that directly attaches the sensor unit to an edge of an opening of a module and then attaches the module to the container main body through an O ring. However, in the structures, since the sensor unit is adhered to the edge of the opening, if a variation in size exists, it is difficult to secure sealability. Further, if the sensor unit is directly adhered to the edge of the opening of the container main body or the edge of the opening of the module, it is likely to be influenced by ink waves or ink bubbles, and thus erroneous detection may occur.

If leakage in a flow passage occurs in a region where presence/absence of ink is to be detected by vibration of the piezoelectric element, detection performance may be degraded. Accordingly, leakage in the flow passage needs to be reliably prevented. In addition, since the ink detection is performed using the vibration, it is necessary to avoid a method of sealing that may have an adverse effect on a vibration characteristic. Therefore, a seal structure that satisfies the above conditions and has good assembling workability is demanded.

### SUMMARY

An advantage of some aspects of the invention is to provide a container that can simply and reliably perform sealing when a sensor unit is attached to a container main body with no effect by size accuracy of parts, and prevent leakage with no effect by ink waves or ink bubbles, thereby enhancing detection performance. The advantage can be attained as at least one of the following aspects:

A first aspect of the invention provides a container includes a container main body that has a delivery path for delivering a liquid stored in the inside to the outside, a sensor accommodating portion that is provided in the container main body to be located in the vicinity of an end of the delivery path, a liquid detection sensor unit that is mounted on the sensor accommodating portion, an upstream buffer chamber and a downstream buffer chamber that are provided in the container main body, are close to the sensor accommodating portion through a sensor receiving wall, and are interposed in serial in the delivery path so as to communicate with an upstream side and a downstream side of the delivery path, respectively, an elastic seal member that seals between the sensor unit and the sensor receiving wall, and a press spring that presses the sensor unit toward the sensor receiving wall, and applies a surface pressure required for sealing to the seal member, the sensor unit, and the sensor receiving wall while crushing the seal member. The sensor unit has a sensor cavity that receives a liquid as a detection object, a bottom surface of the sensor cavity being opened to receive the liquid, a sensor chip that has a vibrating plate for closing a top surface of the sensor cavity and a piezoelectric element disposed on a top surface of the vibrating plate, and a unit base, a bottom surface of which faces the sensor receiving wall through the seal member when the sensor unit is mounted on the sensor accommodating portion. The unit base has an entrance-side flow passage and an exit-side flow passage provided with respect to the sensor cavity, the entrance-side flow passage and the exit-side flow passage serving as liquid storage spaces communicating with the sensor cavity. The sensor receiving wall has an upstream communicating port that allows entrance-side flow passage to communicate with the upstream buffer chamber, and a downstream communicating port that allows the exit-side flow passage to communicate with the downstream buffer chamber, the upstream communicating port and the downstream communicating port being provided inside the seal member. The liquid is supplied from an upstream side of the delivery path to the sensor cavity through the upstream buffer chamber, the upstream communicating port, and the entrance-side flow passage, and then is discharged from the sensor cavity to a downstream side of the delivery path through the exit-side flow passage, the downstream communicating port, and the downstream buffer chamber. The seal member has an upstream seal portion that surrounds and seals the periphery of a communicating portion of the upstream communicating port of the sensor receiving wall and the entrance-side flow passage of the unit base, and a downstream seal portion that surrounds and seals the periphery of a communicating portion of the downstream communicating port of the sensor receiving wall and the exit-side flow passage of the unit base.

In the container according to the first aspect of the invention, the seal member may have, as a single body, a ring-shaped circumferential seal portion that surrounds the periphery of the communicating portion of the upstream communicating port of the sensor receiving wall and the entrance-side flow passage of the unit base and the periphery of the communicating portion of the downstream communicating port of the sensor receiving wall and the exit-side flow passage of the unit base, and a central partition portion that crosses the circumferential seal portion so as to divide the upstream communicating port and the downstream communicating port. Individual halves of the circumferential seal portion and the central partition portion may form the upstream seal portion and the downstream seal portion.

In the container according to the first aspect of the invention, a sectional area of the central partition portion may be set smaller than a sectional area of the circumferential seal portion, and a welding line when the seal member is produced as a single body by injecting molding may be set on the central partition portion.

In the container according to the first aspect of the invention, the seal member may be molded, together with the unit base, by two-color molding.

In the container according to the first aspect of the invention, the central partition portion may be interposed between the sensor receiving wall and the unit base at a position recessed from spaces that allow the communicating ports of the sensor receiving wall to communicate with the flow passages of the unit base. Further, the entrance-side flow passage and the exit-side flow passage of the unit base may be formed in slope shapes or step shapes in order to increase a gap between opening ends of the entrance-side flow passage and the exit-side flow passage of the unit base close to the sensor receiving wall so as to meet the condition.

According to the first aspect of the invention, the elastic ring-shaped seal member is interposed between the sensor unit and the sensor receiving wall, and the sensor unit is pressed toward the sensor receiving wall by the press spring. Then, a space between the sensor unit and the sensor receiving wall is sealed while the seal member is crushed. Accordingly, assembling when the sensor unit is separately prepared, and then the sensor unit is mounted on the container main body can be simplified compared with a case where an adhesive is used. Further, since a variation in size between the parts can be absorbed by elasticity of the seal member, reliable sealing can be performed through simple assembling. In addition, since a liquid storage space that is sealed by the seal member is secured in front of the sensor cavity (opening side), the sensor unit is rarely influenced by ink waves or ink bubbles.

According to the first aspect of the invention, the seal member has the upstream seal portion that surrounds and seals the periphery of the communicating portion of the upstream communicating port of the sensor receiving wall and the entrance-side flow passage of the unit base, and the downstream seal portion that surrounds and seals the periphery of the communicating portion of the downstream communicating port of the sensor receiving wall and the exit-side flow passage of the unit base. That is, the seal member independently seals the upstream and downstream communicating portions. Therefore, the whole quantity of the liquid can be allowed to reliably flow in the sensor cavity, without causing leakage of the liquid from an upstream communicating path to a downstream communicating path. As a result, the operation of the sensor can be stabilized, and erroneous detection can be prevented.

According to the first aspect of the invention, since the central partition portion may isolate the upstream communicating path from the downstream communicating path, the whole quantity of the liquid can be allowed to flow in the sensor cavity with no leakage halfway. Further, the seal member as the single body has the circumferential seal portion and the central partition portion, thereby forming the upstream seal portion and the downstream seal portion. Therefore, required sealing performance can be obtained without increasing the number of parts.

As regards the functions of the circumferential seal portion and the central partition portion, first, the circumferential seal portion is to prevent the liquid flowing in the internal flow passage from leaking to the outside. Therefore, high sealing performance is required so as to prevent the liquid from leaking under the condition that a difference between internal and external pressures exists. Meanwhile, the central partition portion is to prevent the liquid flowing from the upstream side in the same flow passage to the downstream side. In this case, even though leakage occurs, a serious situation, such as liquid leakage to the outside, is not caused. Further, since a pressure difference exists in the same flow passage and is very small, leakage rarely occurs. Therefore, a level of sealing performance entirely different from the circumferential seal portion is demanded.

According to the first aspect of the invention, the welding line that is to be inevitably formed in injection molding may be set on the central partition portion, not on the circumferential seal portion. The presence of the welding line certainly has an adverse effect on the sealing performance. However, with the above-described configuration, even though leakage occurs due to the presence of the welding line, the effect considerably becomes small compared with a case where the welding line exits in the circumferential seal portion, and is suppressed enough not to cause any real harm. That is, a substantial pressure difference does not exist between the flow passages partitioned by the central partition portion, and thus the presence of the small welding line does not matter.

The position control of the welding line can be performed by making the sectional area of the central partition portion smaller than the sectional area of the circumferential seal portion, that is, by making the central partition portion thinner than the circumferential seal portion. Specifically, a filling speed of molding resin can be controlled by making the sectional areas of the circumferential seal portion and the central partition portion different from each other. Therefore, the welding line can be formed in the central partition portion.

According to the first aspect of the invention, the seal member may be molded, together with the unit base, by two-color molding. Therefore, a lot of trouble in handling the parts can be reduced, and thus production efficiency can be enhanced.

According to the first aspect of the invention, the central partition portion of the seal member may be interposed between the sensor receiving wall and the unit base at the position recessed from the spaces that allow the communicating ports of the sensor receiving wall to communicate with the flow passages of the unit base, and the central partition portion of the seal member is not directly exposed in the communicating path. Therefore, there rarely cause the case where the central partition portion obstructs the liquid flow and has an adverse effect on detection performance. On the sensor chip side, the gap between the entrance-side flow passage and the exit-side flow passage in the unit base becomes small. However, since the entrance-side flow passage and the exit-side flow passage in the unit base may be formed in the slope shapes or step shapes, the gap between the entrance-side flow passage and the exit-side flow passage is widened. Therefore, the central partition portion can be naturally disposed to satisfy the above condition.

A second aspect of the invention provides a container comprising: a container main body that has a delivery path for delivering liquid stored in the inside to the outside; a sensor accommodating portion that is provided in the container main body to be located in the vicinity of an end of the delivery path; a liquid detection sensor unit that is mounted on the sensor accommodating portion, and has a sensor cavity that receives the liquid as a detection object, a bottom surface of the sensor cavity being opened to receive the liquid, a sensor chip that has a vibrating plate for closing a top surface of the sensor cavity and a piezoelectric element disposed on a top surface of the vibrating plate; a sensor receiving wall that defines a part of the sensor accommodating portion, and having a first communicating port that allows the liquid stored in the inside to flow into the sensor cavity, and a second communicating port that allows the liquid stored in the sensor cavity to flow to the outside; and an elastic seal member that seals between the sensor unit and the sensor receiving wall and has an upstream seal portion that surrounds and seals the periphery of a part of the delivery path from the inside to the sensor cavity, and a downstream seal portion that surrounds and seals the periphery of a part of the delivery path from the sensor cavity to the outside.

In the container according to the second aspect of the invention, the seal member may have, as a single body, a ring-shaped circumferential seal portion and a central partition portion that crosses the circumferential seal portion to define the upstream seal portion and the downstream seal portion.

In the container according to the second aspect of the invention, a sectional area of the central partition portion may be set smaller than a sectional area of the circumferential seal portion.

In the container according to the second aspect of the invention, a welding line when the seal member is produced as a single body by injecting molding may be set on the central partition portion.

In the container according to the second aspect of the invention, the sensor unit may further have a unit base, a bottom surface of which faces the sensor receiving wall through the seal member when the sensor unit is mounted on the sensor accommodating portion.

In the container according to the second aspect of the invention, the seal member may be molded, together with the unit base, by two-color molding.

In the container according to the second aspect of the invention, the central partition portion of the seal member may not be directly exposed in the delivery path.

In the container according to the second aspect of the invention, the ring-shaped circumferential seal portion of the seal member may not be directly exposed in the delivery path.

In the container according to the second aspect of the invention, the central partition portion and the ring-shaped circumferential seal portion of the seal member may not be directly exposed in the delivery path.

In the container according to the second aspect of the invention, the upstream seal portion and the downstream seal portion may be separately formed.

The present disclosure relates to the subject matter contained in Japanese patent application No. 2005-380292 filed on Dec. 28, 2005, which is expressly incorporated herein by reference in its entirety.

### BRIEF DESCRIPTION OF THE DRAWINGS

FIG. 1 is a perspective view showing the schematic configuration of an ink jet recording apparatus (liquid jetting apparatus) that uses an ink cartridge (container) according to an embodiment of the invention.

FIG. 2 is an exploded perspective view showing the schematic configuration of the ink cartridge according to the embodiment of the invention.

FIG. 3 is a diagram showing the schematic configuration of the ink cartridge according to the embodiment of the invention, and in particular, is an exploded perspective view showing the configuration of a sensor unit, a spring, a seal cover, and a circuit board.

FIG. 4 is an exploded perspective view of the sensor unit in the ink cartridge according to the embodiment of the invention.

FIG. 5 is an exploded perspective view of the sensor unit as viewed from an angle different from FIG. 4.

FIG. 6 is a front view of a portion where the sensor unit and the spring are incorporated into a sensor accommodating recess portion in the embodiment of the invention.

FIG. 7 is a cross-sectional view taken along the line VII-VII of FIG. 6.

FIG. 8 is a cross-sectional view of a portion where the sensor unit and the spring are incorporated into the sensor accommodating recess portion, as viewed from a front direction.

FIG. 9 is a cross-sectional view of essential parts of the sensor unit.

FIG. 10 is a cross-sectional view taken along the line X-X of FIG. 9.

FIG. 11 is a plan view showing the configuration of a sealing in this embodiment.

FIG. 12 is a diagram illustrating a method of filling molding resin in the sealing.

FIG. 13 shows a comparative example, which corresponds to FIG. 8.

FIG. 14 is a plan view showing the configuration of a sealing in the comparative example.

FIG. 15 is a diagram illustrating a method of filling molding resin in the sealing of FIG. 14.

FIG. 16 shows another embodiment of the invention, which corresponds to FIG. 8.

### DESCRIPTION OF EXEMPLARY EMBODIMENTS

An ink cartridge (liquid container) having a liquid detection function according to an embodiment of the invention will now be described with reference to the drawings.

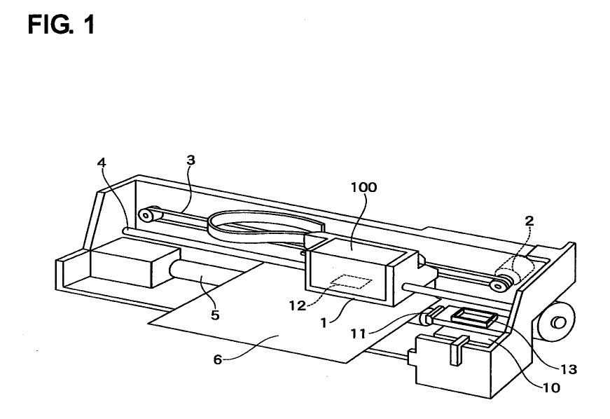

FIG. 1 shows the schematic configuration of an ink jet recording apparatus (liquid jetting apparatus) that uses the ink cartridge according to this embodiment. In FIG. 1, reference numeral 1 denotes a carriage. The carriage 1 is guided by a guide member 4 and reciprocates in an axial direction of a platen 5 through a timing belt 3 that is driven by a carriage motor 2.

An ink jet recording head 12 is mounted on a side of the carriage 1 facing a recording paper 6, and an ink cartridge 100 that supplies ink to the recording head 12 is detachably mounted above the recording head 12.

A cap member 13 is disposed at a home position (a left side in the drawing) as a non-printing region of the recording apparatus. The cap member 13 is pressed into contact with a nozzle formation surface of the recording head 12 and forms a closed space with the nozzle formation surface when the recording head 12 mounted on the carriage 1 is moved to the home position. Then, a pump unit 10 that applies a negative pressure to the closed space formed by the cap member 13 so as to perform cleaning or the like is disposed below the cap member 13.

In the periphery of the cap member 13 close to a printing region, a wiping unit 11 having an elastic plate, such as rubber, is disposed to advance and retreat, for example, in a horizontal direction with respect to the movement trace of the recording head 12. If necessary, when the carriage 1 reciprocates toward the cap member 13, the wiping unit 11 wipes the nozzle formation surface of the recording head 12.

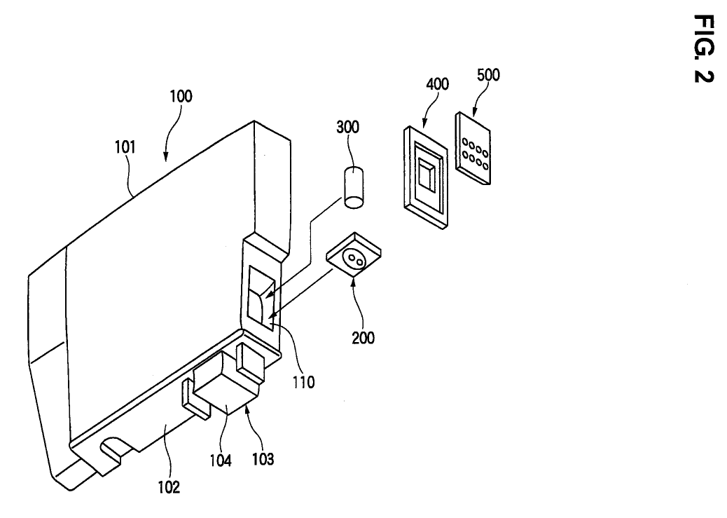

FIG. 2 is a perspective view showing the schematic configuration of the ink cartridge 100. A sensor unit 200 that is a main part having a liquid detection function is incorporated into the ink cartridge 100.

The ink cartridge 100 has a cartridge case (container main body) 101, formed of resin, that has an ink storage portion (now shown) therein, and a cover 102, formed of resin, that is mounted to cover a lower end surface of the cartridge case 101. The cover 102 is provided to protect various seal films that are adhered to the lower end surface of the cartridge case 101. An ink delivery portion 103 is provided to protrude from the lower end surface of the cartridge case 101. A cover film 104 is adhered to a lower end surface of the ink delivery portion 103 so as to protect an ink delivery port (liquid outlet port) (not shown).

A sensor accommodating recess portion (sensor accommodating portion) 110 that accommodates the sensor unit 200 is provided on a side of the cartridge case 101 having a fine width. The sensor unit 200 and a compressed coil spring (press spring) 300 are accommodated in the sensor accommodating recess portion 110.

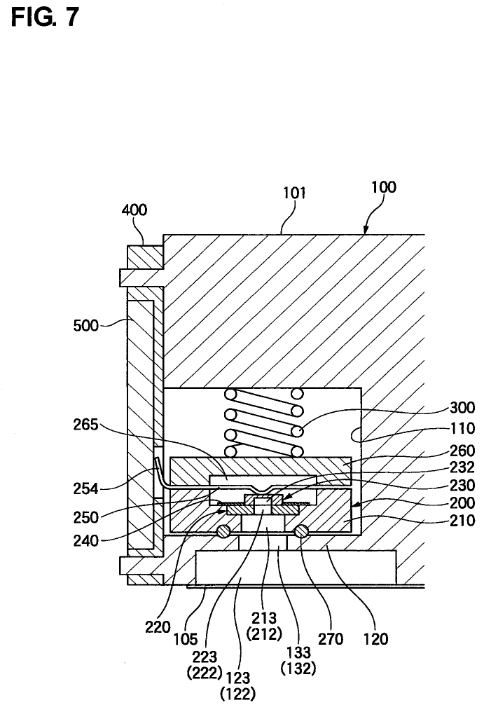

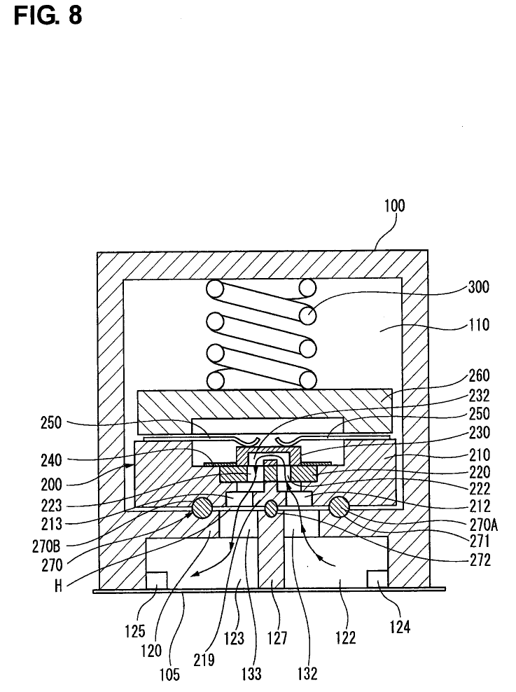

The compressed coil spring (hereinafter, simply referred to as spring) 300 presses the sensor unit 200 on a sensor receiving wall 120 (see FIGS. 7 and 8) of an inner bottom portion of the sensor accommodating recess portion 110 and crushes a sealing 270, thereby securing sealability between the sensor unit 200 and the cartridge case 101.

The sensor accommodating recess portion 110 is formed in the side of the cartridge case 101 having a fine width, and the sensor unit 200 and the spring 300 are inserted into from the opening of the side. Then, the opening of the side of the sensor accommodating recess portion 110 is closed by a seal cover 400, to which a board 500 is externally attached, in a state where the sensor unit 200 and the spring 300 are accommodated therein.

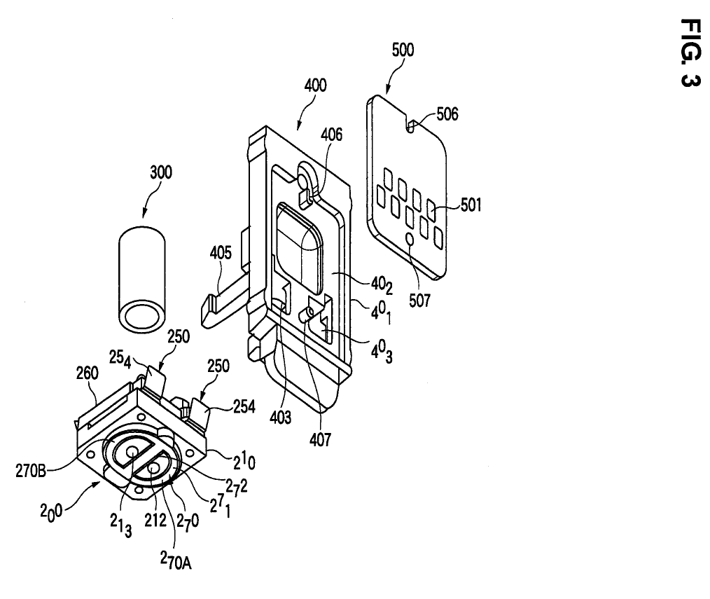

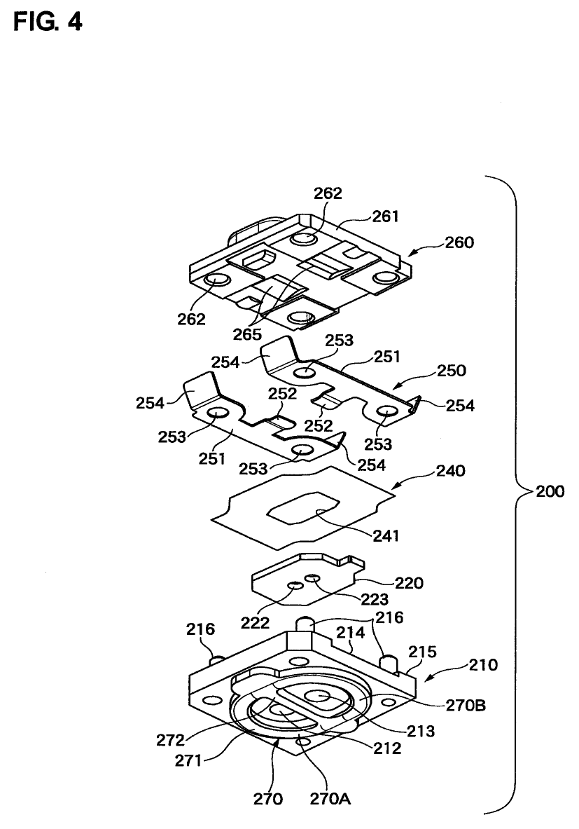

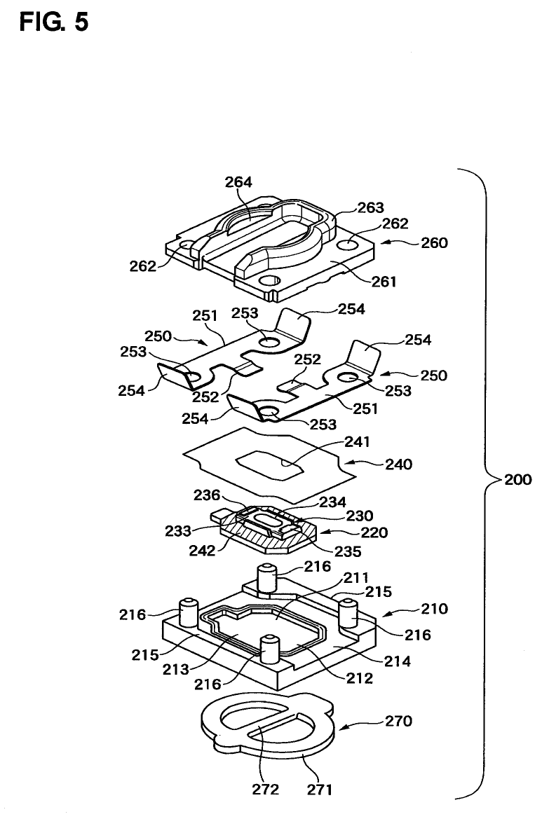

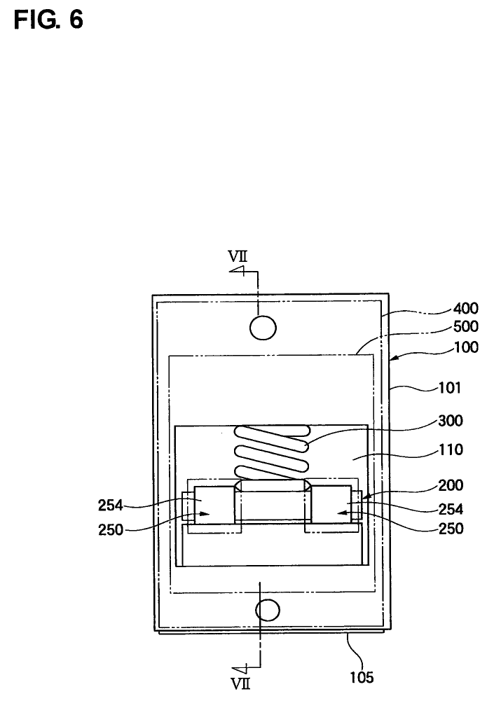

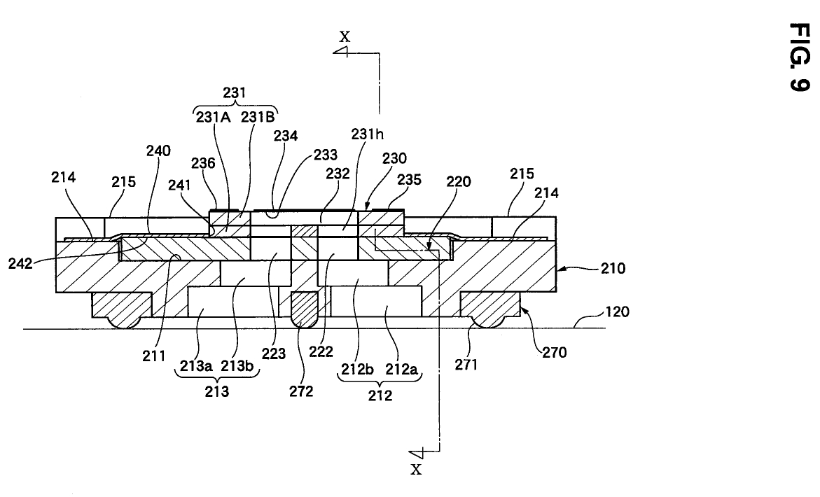

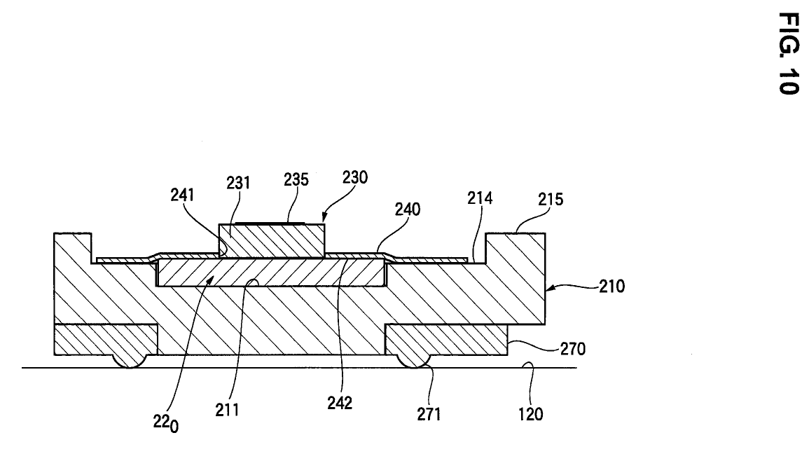

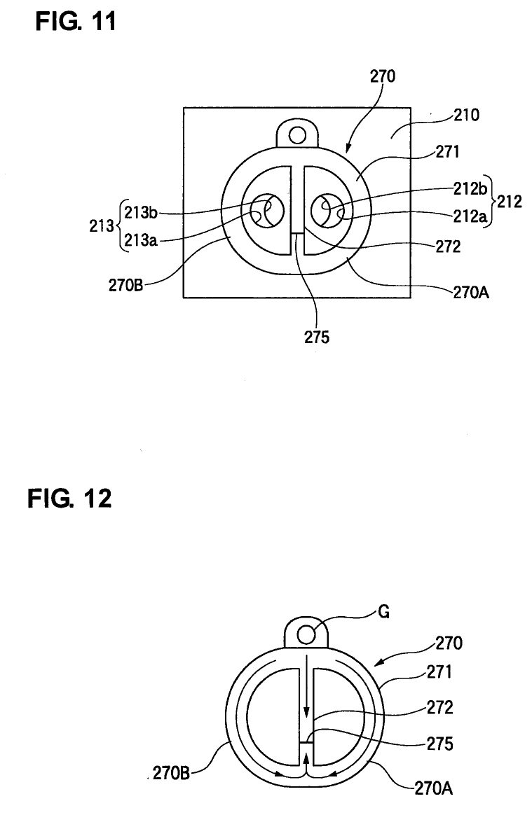

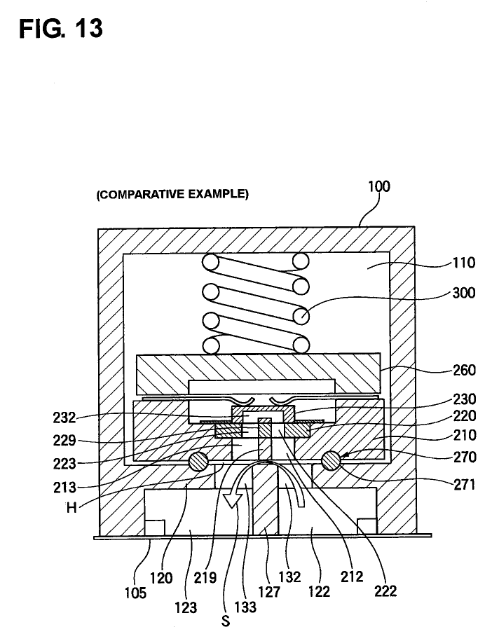

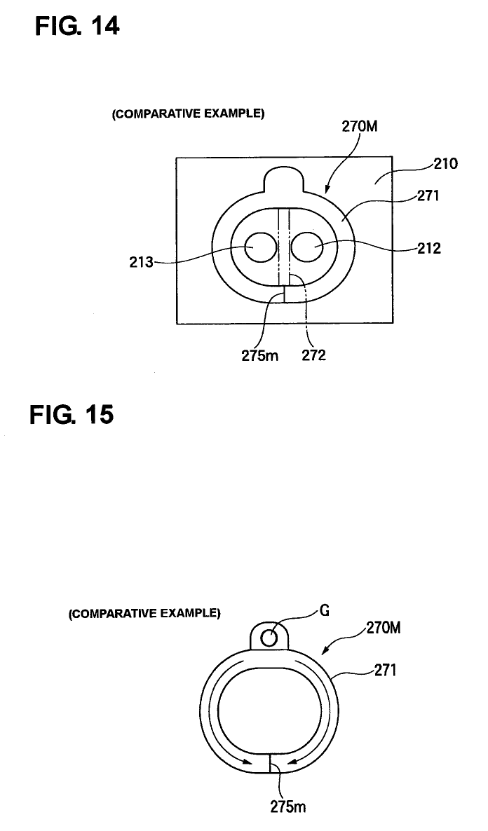

FIG. 3 is an exploded perspective view showing the configuration of the sensor unit 200, the spring 300, the seal cover 400, and the board 500. FIG. 4 is an exploded perspective view of the sensor unit 200. FIG. 5 is an exploded perspective view of the sensor unit 200 as viewed from a different angle. FIG. 6 is a front view of a portion where the sensor unit 200 and the spring 300 are incorporated into the sensor accommodating recess portion 110. FIG. 7 is a cross-sectional view taken along the line VII-VII of FIG. 6. FIG. 8 is a cross-sectional view of a portion where the sensor unit 200 and the spring 300 are incorporated into the sensor accommodating recess portion 110, as viewed from a front direction. FIG. 9 is a cross-sectional view of essential parts of the sensor unit 200. FIG. 10 is a cross-sectional view taken along the line X-X of FIG. 9. FIGS. 11 and 12 are plan views showing the configuration of the sealing 270 in this embodiment. FIG. 13 shows a comparative example, which corresponds to FIG. 8. FIGS. 14 and 15 are plan views showing the configuration of a sealing in the comparative example.

As shown in FIGS. 7 and 8, the sensor receiving wall 120 that receives a lower end of the sensor unit 200 is provided in the inner bottom portion of the sensor accommodating recess portion 110 of the cartridge case 101. The sensor unit 200 is placed on a flat top surface of the sensor receiving wall 120, and the sealing (ring-shaped seal member) 270 at the lower end of the sensor unit 200 is pressed into contact with the sensor receiving wall 120 by an elastic force of the spring 300.

A pair of upstream and downstream sensor buffer chambers 122 and 123 are provided below the sensor receiving wall 120 to be divided in a horizontal direction with a partition wall 127 (see FIG. 8) interposed therebetween. In addition, a pair of communicating ports (flow passages) 132 and 133 are provided in the sensor receiving wall 120 to correspond to the sensor buffer chambers 122 and 123. Though not shown, a delivery flow passage that delivers stored ink to the outside is provided in the cartridge case 101. The sensor buffer chambers 122 and 123 and the sensor unit 200 are provided in the periphery of an end of the delivery flow passage (in the periphery of an ink delivery port).

In this case, the upstream sensor buffer chamber 122 communicates with an upstream delivery path through a connection hole 124, and the downstream sensor buffer chamber 123 communicates with a downstream delivery path through a connection hole 125. Further, the lower surfaces of the sensor buffer chambers 122 and 123 are opened, not closed by a rigid wall, and the opening is covered with a seal film 105 formed of resin.

As shown in FIGS. 4 and 5, the sensor unit 200 has a plate-shaped unit base 210, formed of resin, that has a recess place 211 at its top surface, a metallic plate sensor base 220 that is accommodated in the recess place 211 of the top surface of the unit base 210, a sensor chip 230 that is placed on and fixed to the top surface of the sensor base 220, an adhesive film 240 that adheres and fixes the sensor base 220 to the unit base 120, a pair of terminal plates 250 that are disposed above the unit base 210 and has the same shape, a press cover 260 of the terminal plates 250, and a sealing 270, formed of rubber, that is disposed on a lower surface of the unit base 210.

The details of the individual parts will now be described. As shown in FIG. 5, the unit base 210 has the recess place 211 into which the sensor unit 220 is fitted at a center of its top surface, and mounting walls 215 that are provided outside of a top surface wall 214 in the vicinity of the recess place 211 and are set higher than the top surface wall 214 by one step. A pair of mounting walls 215 are provided to face each other with the recess place 211 interposed therebetween. Four support pins 216 are located above the mounting walls 215 and provided erect at four corners of the top surface of the unit base 210.

As shown in FIG. 4, an entrance-side flow passage 212 and an exit-side flow passage 213 (liquid storage space) of circular through-holes are provided in a bottom wall of the recess place 211. Further, the sealing 270 is formed in the lower surface of the unit base 210 as a single body. The entrance-side flow passage 212 and the exit-side flow passage 213 are located inside the sealing 270.

As shown in FIGS. 3 to 5, 11, and 12, the sealing 270 has an upstream seal portion 270A that surrounds the periphery of a communicating portion of the upstream communicating port 132 of the sensor receiving wall 120 and the entrance-side flow passage 212 of the unit base 210, and a downstream seal portion 270B that surrounds the periphery of a communicating portion of the downstream communicating port 133 of the sensor receiving wall 120 and the exit-side flow passage 213 of the unit base 210.

In particular, the sealing 270 has, as a single body, a ring-shaped circumferential seal portion 271 that surrounds the periphery of the communicating portion of the upstream communicating port 132 of the sensor receiving wall 120 and the entrance-side flow passage 212 of the unit base 210 and the periphery of the communicating portion of the downstream communicating port 133 of the sensor receiving wall 120 and the entrance-side flow passage 213 of the unit base 210, and a central partition portion 272 that crosses the center of the circumferential seal portion 271 so as to divide the upstream communicating portion and the downstream communicating portion. Individual halves of the circumferential seal portion 217 and the central partition portion 272 form the upstream seal portion 270A and the downstream seal portion 270B are formed as a single body.

A sectional area of the central partition portion 272 is set smaller than a sectional area of the circumferential seal portion 271, that is, the central partition portion 272 is formed thinner than the circumferential seal portion 271. As shown in FIGS. 11 and 12, a welding line 275 when the sealing 270 is produced by injection molding as a single body is set on the central partition portion 272. Further, the sealing 270 having such a shape is molded, together with the unit base 210, by two-color molding.

As shown in FIGS. 8 and 9, the entrance-side flow passage 212 and the exit-side flow passage 213 in the unit base 210 are formed in step shapes by two communicating holes 212a and 212b, and 213a and 213b such that the central partition portion 272 is interposed between the sensor receiving wall 120 and the unit base 210 at a position recessed from spaces that allow the communicating ports 132 and 133 of the sensor receiving wall 120 to communicate with the flow passages 212 and 213 of the unit base 210. Accordingly, a large gap between opening ends of the entrance-side flow passage 212 and the exit-side flow passage 213 of the unit base 210 close to the sensor receiving wall 210 is secured.

The sensor base 220 is formed of a metal plate, such as stainless or the like, having higher rigidity than resin for the sake of enhancing acoustic performance of the sensor. The sensor base 220 has a rectangular shape, four corners of which are rounded, and has an entrance-side flow passage 222 and an exit-side flow passage 223 (liquid storage spaces) of two through-holes to correspond to the entrance-side flow passage 212 and the exit-side flow passage 213 of the unit base 210.

An adhesive layer 242 is formed on the top surface of the sensor base 220, for example, by attaching a both-sided adhesive film or coating an adhesive. The sensor chip 230 is mounted on the adhesive layer 242 and then is fixed and adhered thereto.

As shown in FIGS. 8, 9, and 10, the sensor chip 230 has a sensor cavity 232 that receives ink (liquid) as a detection object. A bottom surface of the sensor cavity 232 is opened to receive ink, and a top surface thereof is closed by a vibrating plate 233. A piezoelectric element 234 is disposed on a top surface of the vibrating plate 233.

Specifically, as shown in FIGS. 9 and 10, the sensor chip 230 has a ceramic chip main body 231 that has the sensor cavity 232 of a circular opening as a center, the vibrating plate 233 that is laminated on a top surface of the chip main body 213 and forms a bottom surface wall of the sensor cavity 232, the piezoelectric element 234 that is laminated on the vibrating plate 233, and electrodes 235 and 236 that are laminated on the chip main body 231.

The chip main body 231 of the sensor chip 230 has a two-layered structure of a first layer 231A close to the sensor base 220 and a second layer 231B close to the vibrating plate 233. Two circular holes 231h that form parts of the upstream and downstream flow passages are formed in the first layer 231A. The sensor cavity 232 is formed only in the second layer 231B. In this case, the sensor cavity 232 of the second layer 231B is formed in an elliptic shape to include the two holes 231h of the first layer 231A. Further, the holes 231h of the first layer 231A are formed to overlap the entrance-side flow passage 222 and the exit-side flow passage 223 of the sensor base 220.

Though not specifically shown, the piezoelectric element 234 has upper and lower electrode layers that are connected to the electrodes 235 and 236, respectively, and a piezoelectric layer that is laminated between the upper and lower electrode layers. The piezoelectric element 234 has a function of judging an ink end, for example, using a difference in electric characteristic by presence/absence of ink in the sensor cavity 232. As a material for the piezoelectric layer, lead zirconate titanate (PZT), lead lanthanum zirconate titanate (PLZT), or leadless piezoelectric film in which lead is not used.

The sensor chip 230 is integrally fixed to the sensor base 220 by the adhesive layer 242 by placing the lower surface of the chip main body 231 at a central portion of the top surface of the sensor base 220. The adhesive layer 242 also seals between the sensor base 220 and the sensor chip 230. Further, the entrance-side flow passages 222 and 212 and the exit-side flow passages 223 and 213 (liquid storage spaces) of the sensor base 220 and the unit base 210 communicate with the sensor cavity 232 of the sensor chip 230. With this configuration, ink enters the sensor cavity 232 through the entrance-side flow passages 212 and 222, and is discharged from the sensor cavity 232 through the exit-side flow passages 223 and 213.

As such, the metallic sensor base 220, on which the sensor chip 230 is mounted, is accommodated in the recess place 211 of the top surface of the unit base 210. Then, the adhesive film 240 formed of resin is covered from the above, and then the sensor base 220 and the unit base 210 are adhered to each other as a single body.

That is, the adhesive film 240 has an opening 241 at its center. The adhesive film 240 is covered from the above in a state where the sensor base 220 is accommodated in the recess place 211 of the top surface of the unit base 210, and the sensor chip 230 is exposed through the opening 241 at the center. Then, an inner circumference of the adhesive film 240 is adhered to the top surface of the sensor base 220 by the adhesive layer 242, and an outer circumference of the adhesive film 240 is adhered to the top surface wall 214 in the periphery of the recess place 211 of the unit base 210. That is, the adhesive film 240 is adhered over top surfaces of two parts (the sensor base 220 and the unit base 210. Accordingly, the sensor unit 220 and the unit base 210 are fixed to each other and a space therebetween is sealed.

In this case, the top surface of the sensor base 220 protrudes above the recess place 211 of the unit base 210, and the adhesive film 240 is adhered to the top surface of the sensor base 220 at a position higher than an adhesion position to the top surface wall 214 in the periphery of the recess place 211 of the unit base 210. As such, when the height of a film adhesion surface to the sensor base 220 is set to a position above the height of a film adhesion surface to the unit base 210, a step is formed. Accordingly, the sensor base 220 can be pressed by the adhesive film 240, and an adhesive force of the sensor base 220 to the unit base 210 can be improved. Further, rattle-free mounting can be performed.

As shown in FIGS. 4 and 5, each terminal plate 250 has a bar-shaped board portion 251, a spring piece 252 that is provided to protrude to a side edge of the board portion 251, mounting holes 253 that are formed on both sides of the board portion 251, and bent pieces 254 that are formed at both ends of the board portion 251. In a state where the terminal plates 250 are positioned by inserting the support pins 216 into the mounting holes 253, the terminal plates 250 are disposed on the top surfaces of the mounting walls 215 of the unit base 210.

Next, the press cover 260 is placed from the above, and the terminal plates 250 are interposed between the unit base 210 and the press cover 260. In this state, the spring pieces 252 are in contact with and connected to the electrodes 235 and 236 of the top surface of the sensor chip 230, respectively. Moreover, the press cover 260 is a flat plate frame that is placed on the top surface of the mounting walls 215 of the unit 210 with the terminal plates 250 interposed therebetween.

The press cover 260 has a flat plate portion 261 that is placed on the top surfaces of the mounting walls 215 of the unit base 210 with the board portions 251 of the terminal plates 250 interposed therebetween, four mounting holes 262 that are disposed at four corners of the flat plate portion 261 and into which the support pins 216 of the unit base 210 are fitted, an erect wall 263 that is provided at a central top surface of the flat plate portion 261, a spring receiving seat 264 that is provided at the erect wall 263, and recess portions 265 that are provided at a lower surface of the flat plate portion 261 and form relieves of the spring pieces 252 of the terminal plates 250. The press cover 250 is placed on the top surface of the unit base 210 while pressing the terminal plates 250 from the above. With the press cover 250, the sensor base 220 and the sensor chip 230 that are accommodated in the recess place 211 of the top surface of the unit base 210 are protected.

Upon assembling the sensor unit 200 using the above parts, first, the adhesive layer 242 is formed on the entire top surface of the sensor base 220, and the sensor chip 230 is placed on the adhesive layer 242. Then, the sensor chip 230 and the sensor base 220 are fixed to each other by the adhesive layer 242 as a single body and a space therebetween is sealed.

Next, the sensor base 220 that is integrated with the sensor chip 230 is accommodated in the recess place 211 of the top surface of the unit base 210. In this state, the adhesive film 240 is covered from the above. At this time, the inner circumference of the adhesive film 240 is adhered to the top surface of the sensor base 220 through the adhesive layer 242, and the outer circumference thereof is adhered to the top surface wall 214 in the periphery of the recess place 211 of the unit base 210. Accordingly, the sensor base 220 and the unit base 210 are fixed to each other as a single body by the adhesive film 240 and the space therebetween is sealed.

Next, the terminal plates 250 are disposed on the unit base 210 while the support pins 216 of the unit base 210 are fitted into the mounting holes 253, and then the press cover 260 is disposed from the above. With this procedure, the sensor unit 200 can be assembled.

The sensor unit 200 has the above configuration, and the sensor unit 200 is accommodated in the sensor accommodating recess portion 110 of the cartridge case 100, together with the compressed spring 300. In this state, the spring 300 presses the press cover 260 downward, and thus the sensor unit 200 is pressed into contact with the sensor receiving wall 120 in the sensor accommodating recess portion 110 while the sealing 270 provided on the lower surface of the unit case 210 is crushed. Accordingly, sealability between the sensor unit 220 and the cartridge case 101 is secured.

With this assembling process, under a condition that sealability is secured, the upstream buffer chamber 122 in the cartridge case 101 communicates with the entrance-side flow passages 212 and 222 in the sensor unit 200 through the communicating port 132 of the sensor receiving wall 120, and the downstream buffer chamber 123 in the cartridge case 101 communicates with the exit-side flow passages 213 and 223 in the sensor unit 200 through the communicating port 133 of the sensor receiving wall 120. Then, the entrance-side flow passages 212 and 222, the sensor cavity 232, and the exit-side flow passages 213 and 223 are disposed in serial in the delivery path in the cartridge case 101 to be arranged in that order from the upstream side.

Here, an upstream flow passage that is connected to the sensor cavity 232 has the upstream buffer chamber 122 having a large flow passage sectional area, the communicating port 132, and the entrance-side flow passages 212 and 222 having a small flow passage sectional area in the sensor unit 200 (upstream small flow passages). Further, a downstream flow passage that is connected to the sensor cavity 232 has the downstream buffer chamber 123 having a large flow passage sectional area, the communicating port 133, and the exit-side flow passages 213 and 223 having a small flow passage sectional area in the sensor unit 200 (downstream small flow passages).

Accordingly, ink flowing from the upstream side of the delivery path flows into the upstream buffer chamber 122 from an introduction hole 124, and enters the sensor cavity 232 through the upstream communicating path (the communicating port 132 and the entrance-side flow passages 212 and 222). Subsequently, ink passes through the downstream communicating path (the exit-side flow passages 223 and 213) and the downstream buffer chamber 123 from the sensor cavity 232 and then is discharged from a deduction hold 125 to the downstream side of the delivery path.

In the flow passage that is connected to the sensor cavity 232, the communicating paths (the communicating ports 132 and 133, and the entrance-side flow passages 212, 222, 213, and 223) having a smaller flow passage sectional area than those of the buffer chambers 122 and 123 are small flow passages.

As shown in FIG. 3, the seal cover 400 that closes a side opening of the sensor accommodating recess portion 110 has a recess portion 402 that is provided at an outer surface of a plate-shaped cover main body 401 and into which a circuit board 500 is fitted, two openings 403 that are provided at a bottom wall of the recess portion 402 to expose the bent pieces 254 of the individual terminal plates 250, positioning pins 406 and 407 of the circuit board 500, and anchoring claws 405 that are provided to protrude from an inner surface of the cover main body 401 to be anchored to predetermined places in the sensor accommodating recess portion 110. The sensor unit 200 and the spring 300 are mounted on the cartridge case 101 in a state being accommodated in the sensor accommodating recess portion 110. In this state, the board 500 is mounted on the recess portion 402 of the seal cover 400, and thus predetermined contacts 501 of the board 500 are in contact with and connected to the terminal plates 250. Moreover, notches 506 or holes 507 that are engaged with the positioning pins 406 and 407 are provided in the board 500.

Next, a principle of ink detection by the sensor unit 200 will be described.

When ink in the ink cartridge 100 is consumed, stored ink passes through the sensor cavity 232 of the sensor unit 200 and is sent from the ink delivery portion 103 to the recording head 12 of the ink jet recording apparatus.

At this time, in a state where sufficient ink remains in the ink cartridge 100, the inside of the sensor cavity 232 is filled with ink. Meanwhile, if the ink residual quantity in the ink cartridge 100 is decreased, ink does not exist in the sensor cavity 232.

Here, the sensor unit 200 detects a difference in acoustic impedance due to the state change. Accordingly, it can be detected whether sufficient ink remains or ink is consumed by a predetermined amount or more and the residual quantity is decreased.

Specifically, if a voltage is applied to the piezoelectric element 234, the deformation of the piezoelectric element 234 is accompanied by the vibrating plate 233. After the piezoelectric element 234 is forcibly deformed, if the application of the voltage is released, flexural vibration remains in the vibrating plate 233 for a while. The residual vibration is free vibration of the vibrating plate 233 and a medium in the sensor cavity 232. Therefore, if the voltage applied to the piezoelectric element 234 is a pulse wave or square wave, a resonance state of the vibrating plate 233 and the medium after the voltage is applied can be easily obtained.

The residual vibration is the vibration of the vibrating plate 233 and is accompanied by the deformation of the piezoelectric element 234. For this reason, the residual vibration is accompanied by the generation of a counter electromotive force by the piezoelectric element 234. The counter electromotive force is externally detected through the terminal plates 250.

Since a resonant frequency can be specified by the counter electromotive force detected in such a manner, the presence/absence of ink in the ink cartridge 100 can be detected on the basis of the resonant frequency.

According to the above-described embodiment, the elastic sealing 270 is interposed between the sensor unit 200 and the sensor receiving wall 120, and the sensor unit 200 is pressed toward the sensor receiving wall 120 by the spring 300. Then, the space between the sensor unit 200 and the sensor receiving wall 120 is sealed while the sealing 270 is crushed. Therefore, an assembling procedure of separately assembling the sensor unit 200 in advance and then mounting the sensor unit 200 on the cartridge case 101 can be used. Assembling at that time can be simplified compared with a case where an adhesive is used.

A variation in size between the sensor unit 200 and the sensor receiving wall 120 can be absorbed by elasticity of the sealing 270, and thus reliable sealing can be performed through simple assembling. Further, the liquid storage space (the entrance-side flow passages 212 and 222, and the exit-side flow passages 213 and 223) sealed by the sealing 270 is secured in front of the sensor cavity 232 (opening side). Therefore, the sensor unit 200 is rarely influenced by ink waves or ink bubbles.

The press cover 260 that protects the sensor chip 230 is provided above the sensor chip 230, and a load of the press spring 300 acts on the unit base 210 through the press cover 260. Therefore, required sealing performance and vibration performance can be secured with no adverse effect on the sensor chip 230.

In this embodiment, the sealing 270 has the upstream seal portion 270A that surrounds and seals the periphery of the communicating portion of the upstream communicating port 132 of the sensor receiving wall 120 and the entrance-side flow passage 212 of the unit base 210, and the downstream seal portion 270B that surrounds and seals the periphery of the communicating portion of the downstream communicating port 133 of the sensor receiving wall 120 and the exit-side flow passage 213 of the unit base 210. Accordingly, the upstream and downstream communicating portions are separately sealed. Therefore, the liquid can be completely prevented from leaking from the upstream communicating path to the downstream communicating path. As a result, the whole quantity of ink in the sensor cavity 232 can reliably flow in the sensor cavity 232, such that a detection operation can be stabilized and erroneous detection can be prevented.

This will be described with reference to a comparative example of FIG. 13.

In view of the vibration of the sensor unit 200, it is desirable that a small gap (a gap of about 1 to 30 μm) H be secured between the unit base 210 and the sensor receiving wall 120. If the gap is excessively large, leakage that is indicated by an arrow S occurs between the upstream communicating path and the downstream communicating path, and the detection operation is becomes unstable due to a flow not passing through the sensor cavity 232. The control of a free height (the gap H) of the seal portion that can be secured by elasticity of the sealing 270 is difficult due to a variation, which actually causes leakage.

In this embodiment, since the upstream communicating path and the downstream communicating path are completely isolated from each other by the central partition portion 272 that is provided in the sealing 270. Accordingly, the free height (the gap H) of the seal portion can be controlled by freely selecting elasticity of the sealing 270 or the spring 300, without minding the leakage.

The central partition portion 272 is formed in one sealing 270, thereby forming the upstream seal portion 270A and the downstream seal portion 270B. Therefore, required sealing performance can be obtained without increasing the number of parts.

As regards the functions of the circumferential seal portion 271 and the central partition portion 272, first, the circumferential seal portion 271 is to prevent ink flowing in the internal flow passage from leaking to the outside. Therefore, high sealing performance is required so as to prevent ink from leaking under a condition that a difference between internal and external pressures exists. Meanwhile, the central partition portion 272 is to prevent ink flowing from the upstream side in the same flow passage to the downstream side. In this case, even though leakage occurs, a serious situation, such as ink leakage to the outside, is not caused. Further, since a pressure difference exists in the same flow passage and is very small, leakage rarely occurs. Therefore, a level of sealing performance entirely different from the circumferential seal portion 271 is demanded.

In this embodiment, as shown in FIGS. 11 and 12, the welding line 275 that is to be inevitably formed in injection molding is set on the central partition portion 272, not on the circumferential seal portion 271. The presence of the welding line 275 certainly has an adverse effect on sealing performance. However, with the above-described configuration, even though leakage occurs due to the presence of the welding line 275, unlike the sealing 270 not having the central partition portion 272 shown in FIGS. 14 and 15, the effect considerably becomes small compared with a case where a welding line 275m exits in the circumferential seal portion 271, and is suppressed enough not to cause any real harm. That is, a substantial pressure difference does not exist between the flow passages partitioned by the central partition portion 272, and thus the presence of the small welding line 275 does not matter.

The position control of the welding line 275 can be performed by making the sectional area of the central partition portion 272 smaller than the sectional area of the circumferential seal portion 271, that is, by making the central partition portion 272 thinner than the circumferential seal portion 271. Specifically, a filling speed of molding resin can be controlled by making the sectional areas of the circumferential seal portion 271 and the central partition portion 272 different from each other. Therefore, the welding line 275 can be formed on the central partition portion 272.

In this embodiment, the sealing 270 is molded, together with the unit base 210, by two-color molding. Therefore, a lot of trouble in handling the parts can be reduced, and thus production efficiency can be enhanced.

In this embodiment, the central partition portion 272 of the sealing 270 is interposed between the sensor receiving wall 120 and the unit base 210 at the position recessed from the spaces that allow the communicating ports 132 and 133 of the sensor receiving wall 120 to communicate with the flow passages 212 and 213 of the unit base 210, and the central partition portion 272 of the sealing 270 is not directly exposed in the communicating path. Therefore, there is no case where the central partition portion 272 obstructs the ink flow and has an adverse effect on detection performance.

On the sensor chip 230 side, the gap between the entrance-side flow passage 212 and the exit-side flow passage 213 in the unit base 210 becomes small. However, since the entrance-side flow passage 212 and the exit-side flow passage 213 in the unit base 210 are formed in the step shapes, the gap between the opening ends of the entrance-side flow passage 212 and the exit-side flow passage 213 is widened. Therefore, the central partition portion 272 of the sealing 270 can be naturally disposed to satisfy the above condition.

As another effect, the adhesion and sealing of two parts (the metallic sensor base 220 and the resin unit base 210) can be simultaneously performed only by assembling the sensor base 220, on which the sensor chip 230 is mounted, into the unit base 210 from the above, and then attaching the adhesive film 240 over the top surfaces of the two parts, that is, the top surfaces of the sensor base 220 and the unit base 210. Therefore, excellent assembling workability is obtained. Further, since the adhesive film 240 is merely adhered over the two parts, sealing between the parts can be performed, without being influenced by accuracy in size of the individual parts. In addition, for example, when the adhesive film 240 is heated and pressurized by a mass-production machine to be then welded, sealing performance can be enhanced only by controlling temperature or pressure by the mass-production machine. Therefore, stabilization when mass production can be achieved. Further, the adhesive film 240 that controls sealability is easily mounted and has spatial efficiency, and thus the sensor unit 200 can be reduced in size.

The entrance-side flow passages 212 and 222 and the exit-side flow passages 213 and 223 to the sensor cavity 232 are formed in the sensor base 220 and the unit base 210, respectively. Further, ink flows into the sensor cavity 232 through the entrance-side flow passages 212 and 222 and is discharged through the exit-side flow passages 213 and 223. Therefore, ink flows in the sensor cavity 232 to the end, and thus erroneous detection due to retention of the liquid or bubbles in the sensor cavity 232 can be prevented.

The height of the adhesion surface of the adhesive film 240 to the unit base 210 is set to the position lower than the height of the adhesion surface to the sensor unit 220, and thus the step is formed. Therefore, the sensor base 220 can be pressed by the adhesive film 240, and the adhesion of the sensor base 220 to the unit base 210 can be increased. Further, rattle-free mounting can be performed.

The sensor unit is disposed in the vicinity of the end of the delivery flow passage in the cartridge case 101, and the entrance-side flow passages 212 and 222, the sensor cavity 232, and the exit-side flow passages 213 and 223 of the sensor unit 200 are provided in serial in the delivery flow passage to be arranged in that order from the upstream side. Therefore, the liquid residual quantity in the ink cartridge 100 can be accurately detected.

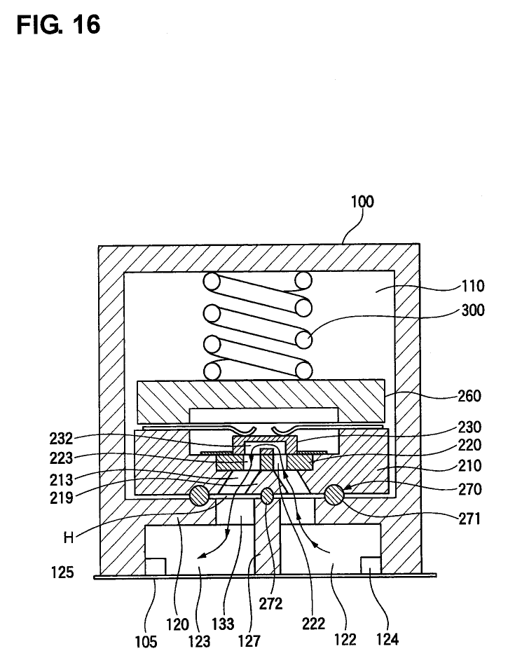

In the above-described embodiment, the entrance-side flow passage 212 and the exit-side flow passage 213 in the unit base 210 are formed in the step shapes, and thus the gap between the opening ends of the entrance-side flow passage 212 and the exit-side flow passage 213 close to the sensor receiving wall 120 is widened. However, as shown in FIG. 16, instead of the step shapes, the entrance-side flow passage 212 and the exit-side flow passage 213 may be formed in slope shapes. In this case, the gap between the opening ends of the entrance-side flow passage 212 and the exit-side flow passage 213 close to the sensor receiving wall 120 may also be widened.

In the above-described embodiment, the upstream seal portion 270A and the downstream seal portion 270B are formed in one sealing 270 as a single body. Alternatively, the upstream seal portion 270A and the downstream seal portion 270B may be separately formed. In this case, for example, two O rings may be provided.

In the above-described embodiment, although the upstream sensor buffer chamber 122 communicates with an upstream delivery path through a connection hole 124, and the downstream sensor buffer chamber 123 communicates with a downstream delivery path through a connection hole 125, the upstream sensor buffer chamber 122 and the downstream sensor buffer chamber 123 may not be provided between the sensor cavity and the inside of the cartridge case 101.

What is claimed is:

1. A container comprising:
a container main body that has a delivery path for delivering liquid stored in the inside to the outside;
a sensor accommodating portion that is provided in the container main body to be located in the vicinity of an end of the delivery path;
a liquid detection sensor unit that is mounted on the sensor accommodating portion;
an upstream buffer chamber and a downstream buffer chamber that are provided in the container main body, are close to the sensor accommodating portion through a sensor receiving wall, and are interposed in serial in the delivery path so as to communicate with an upstream side and a downstream side of the delivery path, respectively;
an elastic seal member that seals between the sensor unit and the sensor receiving wall; and
a press spring that presses the sensor unit toward the sensor receiving wall, and applies a surface pressure required for sealing to the seal member, the sensor unit, and the sensor receiving wall while crushing the seal member,
wherein the sensor unit has:
a sensor cavity that receives liquid as a detection object, a bottom surface of the sensor cavity being opened to receive the liquid,
a sensor chip that has a vibrating plate for closing a top surface of the sensor cavity and a piezoelectric element disposed on a top surface of the vibrating plate, and
a unit base, a bottom surface of which faces the sensor receiving wall through the seal member when the sensor unit is mounted on the sensor accommodating portion,
the unit base has an entrance-side flow passage and an exit-side flow passage provided with respect to the sensor cavity, the entrance-side flow passage and the exit-side flow passage serving as liquid storage spaces communicating with the sensor cavity,
the sensor receiving wall has an upstream communicating port that allows the entrance-side flow passage to communicate with the upstream buffer chamber, and a downstream communicating port that allows the exit-side flow passage to communicate with the downstream buffer chamber, the upstream communicating port and the downstream communicating port being provided inside the seal member,
the liquid is supplied from an upstream side of the delivery path to the sensor cavity through the upstream buffer chamber, the upstream communicating port, and the entrance-side flow passage, and then is discharged from the sensor cavity to a downstream side of the delivery path through the exit-side flow passage, the downstream communicating port, and the downstream buffer chamber, and
the seal member has an upstream seal portion that surrounds and seals the periphery of a communicating portion of the upstream communicating port of the sensor receiving wall and the entrance-side flow passage of the unit base, and a downstream seal portion that surrounds and seals the periphery of a communicating portion of the downstream communicating port of the sensor receiving wall and the exit-side flow passage of the unit base.

2. The container according to claim 1,
wherein the seal member has, as a single body, a ring-shaped circumferential seal portion that surrounds the periphery of the communicating portion of the upstream communicating port of the sensor receiving wall and the entrance-side flow passage of the unit base and the periphery of the communicating portion of the downstream communicating port of the sensor receiving wall and the exit-side flow passage of the unit base, and a central partition portion that crosses the circumferential seal portion so as to divide the upstream communicating port and the downstream communicating port, and
individual halves of the circumferential seal portion and the central partition portion form the upstream seal portion and the downstream seal portion.

3. The container according to claim 2,
wherein a sectional area of the central partition portion is set smaller than a sectional area of the circumferential seal portion, and
a welding line when the seal member is produced as a single body by injecting molding is set on the central partition portion.

4. The container according to claim 3,
wherein the seal member is molded, together with the unit base, by two-color molding.

5. The container according to claim 2,
wherein the central partition portion is interposed between the sensor receiving wall and the unit base at a position recessed from spaces that allow the communicating ports of the sensor receiving wall to communicate with the flow passages of the unit base, and
the entrance-side flow passage and the exit-side flow passage of the unit base are formed in slope shapes or step shapes in order to increase a gap between opening ends of the entrance-side flow passage and the exit-side flow passage of the unit base close to the sensor receiving wall so as to meet the condition.

6. A container comprising:
a container main body that has a delivery path for delivering liquid stored in the inside to the outside;
a sensor accommodating portion that is provided in the container main body to be located in the vicinity of an end of the delivery path;
a liquid detection sensor unit that is mounted on the sensor accommodating portion, and has
a sensor cavity that receives the liquid as a detection object, a bottom surface of the sensor cavity being opened to receive the liquid, and
a sensor chip that has a vibrating plate for closing a top surface of the sensor cavity and a piezoelectric element disposed on a top surface of the vibrating plate;
a sensor receiving wall that defines a part of the sensor accommodating portion, and having a first communicating port that allows the liquid stored in the inside to flow into the sensor cavity, and a second communicating port that allows the liquid stored in the sensor cavity to flow to the outside; and
an elastic seal member that seals between the sensor unit and the sensor receiving wall and has
an upstream seal portion that surrounds and seals the periphery of a part of the delivery path from the inside to the sensor cavity, and
a downstream seal portion that surrounds and seals the periphery of a part of the delivery path from the sensor cavity to the outside.

7. The container according to claim 6,
wherein the seal member has, as a single body, a ring-shaped circumferential seal portion and a central partition portion that crosses the circumferential seal portion to define the upstream seal portion and the downstream seal portion.

8. The container according to claim 7,
wherein a sectional area of the central partition portion is set smaller than a sectional area of the circumferential seal portion.

9. The container according to claim 7, wherein a welding line when the seal member is produced as a single body by injecting molding is set on the central partition portion.

10. The container according to claim 6, wherein the sensor unit further has a unit base, a bottom surface of which faces the sensor receiving wall through the seal member when the sensor unit is mounted on the sensor accommodating portion.

11. The container according to claim 10, wherein the seal member is molded, together with the unit base, by two-color molding.

12. The container according to claim 7, wherein the central partition portion of the seal member is not directly exposed in the delivery path.

13. The container according to claim 7, wherein the ring-shaped circumferential seal portion of the seal member is not directly exposed in the delivery path.

14. The container according to claim 7, wherein the central partition portion and the ring-shaped circumferential seal portion of the seal member are not directly exposed in the delivery path.

15. The container according to claim 6, wherein the upstream seal portion and the downstream seal portion are separately formed.
